(19) United States
(12) Patent Application Publication
(10) Pub. No.: US 2025/0360422 A1
(43) Pub. Date: Nov. 27, 2025

(54) AUTOMATICALLY DETECTING DIFFERENT USERS UNDER THE SAME ACCOUNT AND AUTO-ADAPTING EXPERIENCES

(71) Applicant: Sony Interactive Entertainment Inc., Tokyo (JP)

(72) Inventor: Chen Yao, San Mateo, CA (US)

(21) Appl. No.: 18/673,981

(22) Filed: May 24, 2024

(51) Int. Cl. A63F 13/79

(52) U.S. Cl. CPC A63F 13/79; A63F 2300/5546

(57) ABSTRACT

Personalized experiences for respective users sharing the same computer game system account are provided based on their interactions with games by analyzing deep signals such as browsing history, active times, playing history, and playing style during active sessions. To verify the detection, each user can be automatically prompted to confirm his or her identity, such as through notifications or on-screen prompts. Once verified, the experience can be tailored to each user, including content and artistic styles, to maximize the user's enjoyment and satisfaction.

### FIELD

The present application relates generally to automatically detecting different users under the same account and auto-adapting experiences.

### BACKGROUND

In situations where multiple users in the same household share one computer game console under the same computer game system account, it can be challenging to create personalized experiences tailored to each user's preferences. For instance, a couple may share an account, but the female player may have distinct preferences in content and design styles that differ from the male player. This lack of personalization can hinder the overall enjoyment of the gaming experience.

### SUMMARY

Present principles, in recognizing the above technical challenges, provide personalized experiences for multiple users sharing the same computer game system account. Based on their interactions with games and the platform as automatically detected, each respective user's game experience is adapted to that user. This can be achieved by analyzing deep signals such as browsing history, active times, playing history, and playing style during active sessions. To verify the detection, each user can be automatically prompted to confirm his or her identity, such as through notifications or on-screen prompts. Once verified, the experience can be tailored to each user, including content and artistic styles, to maximize the user's enjoyment and satisfaction. A device is disclosed that stores instructions executable by at least one processor system to execute the above.

In another aspect, a method includes establishing computer game system settings associated with a first player profile for a computer game system account. The method also includes receiving game play signals from a computer game controller. The game play signals control at least one computer game. The method includes, responsive to the game play signals, changing to computer game system settings associated with a second player profile for the computer game system account.

In some embodiments the game play signals control a player character (PC) of the computer game. The game play signals may include specific buttons pushed on the controller and timestamps associated with each button push.

The method may include changing to computer game system settings associated with the second player profile for the computer game system account responsive to a gap in play of the computer game. Without limitation, the game system settings may include one or more of content, content recommendations, advertisements, artistic style of video display, speaker volume, display color background, controller settings, suggested titles, help assistance, accessibility settings, and game presets including one or more of difficulty, performance mode, resolution mode, first or third person view, subtitles, language, and multiplayer session settings.

In example embodiments, the method can include inputting the game play signals to at least one machine learning (ML) model, and receiving the second player profile from the ML model responsive to the inputting.

If desired, the method can include presenting a prompt on at least one display to confirm correct game system settings are established.

In another aspect, a processor system is configured to present, according to first system settings, a computer game via a single user account for a first player being detected as playing on the single user account, and responsive to detecting a second player as playing on the single user account, automatically switch to presenting a computer game according to second system settings.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 illustrates a first player playing a computer game using a first computer game system account;

FIG. 3 illustrates a second player playing a computer game using the same computer game system account as used by the first player;

FIG. 4 illustrates example logic in example flow chart format for initially collecting playing style information from multiple players using the same account;

FIG. 5 illustrates example logic in example flow chart format for establishing a player profile based on received input signals from the game controller and other sensors if desired;

FIG. 6 illustrates a system for training a machine learning (ML) model to establish a player profile based on game playing characteristics;

FIG. 7 illustrates example logic in example flow chart format for using the ML model of FIG. 6;

FIG. 8 illustrates example logic in example flow chart format for establishing a profile subsequent to detecting that multiple players are using the same account;

FIG. 9 illustrates an example screen shot to verify the profile;

FIG. 10 illustrates an example screen shot to change profile settings if desired; and

FIGS. 11 and 12 illustrate example screen shots of respective player profile settings.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers. A processor including a digital signal processor (DSP) may be an embodiment of circuitry. A processor system may include one or more processors.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

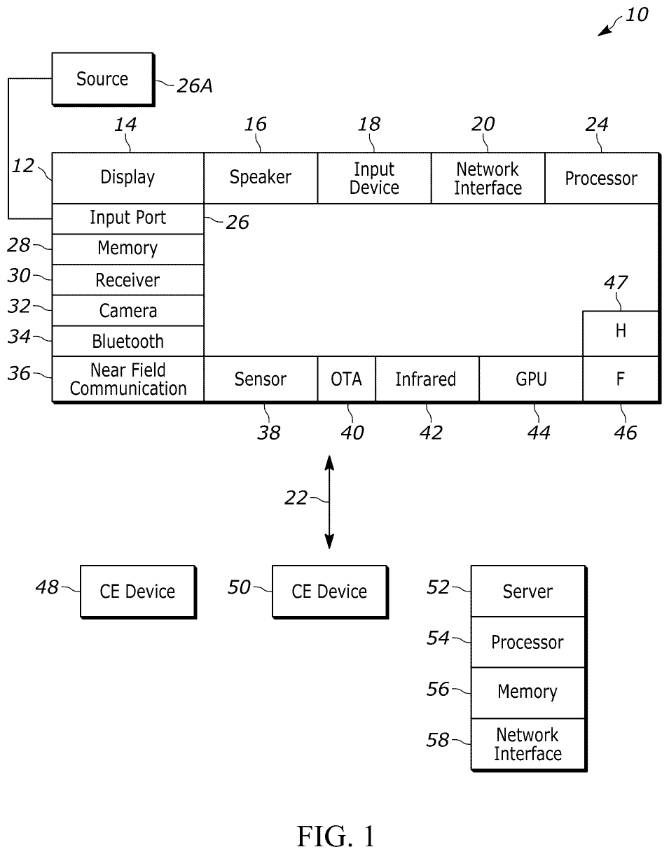

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that are configured and weighted to make inferences about an appropriate output.

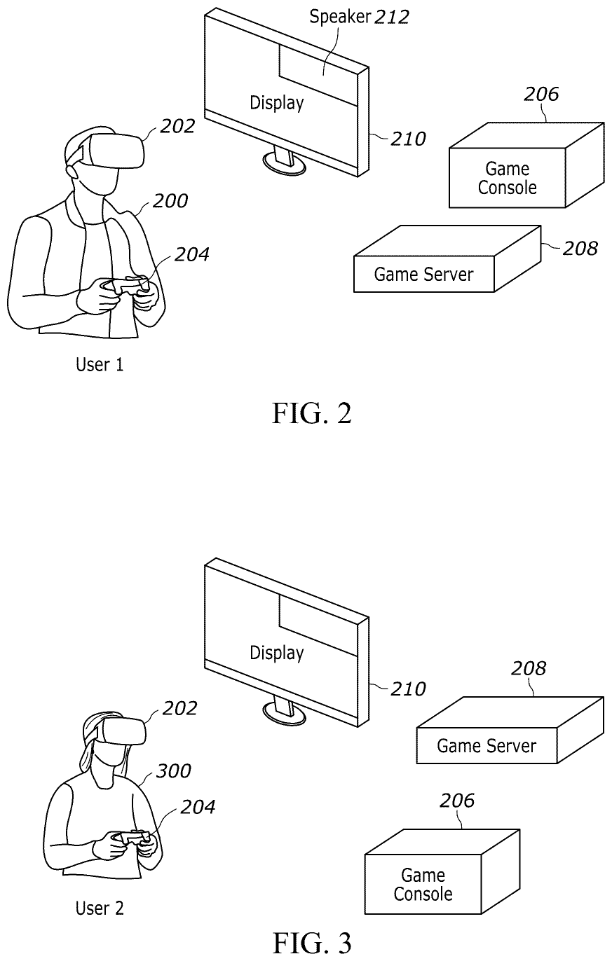

Refer now to FIG. 2. A first user or player 200 who may wear an extended reality (XR) head-mounted display (HMD) 202 and wield a computer game controller 204 can play a computer simulation such as a computer game sourced from a computer game console 206 and/or computer game server 208 and presented on a display 210 with one or more speakers 212. Typically, the first player logs into a computer game system account to play, using an account name and password.

In FIG. 3, a second user or player 300 logging into the same account as the first user 200 may wear the HMD 202 and wield the controller 204 to control the same game or a different game sourced from the console 206 or game server 208 and presented on the display 210. The second player logs into the computer game system account to play, using the same account name and password as used by the first player. Present principles automatically detect a change of playing style on the same account and adjust various settings automatically for the presumably different player as set forth further below.

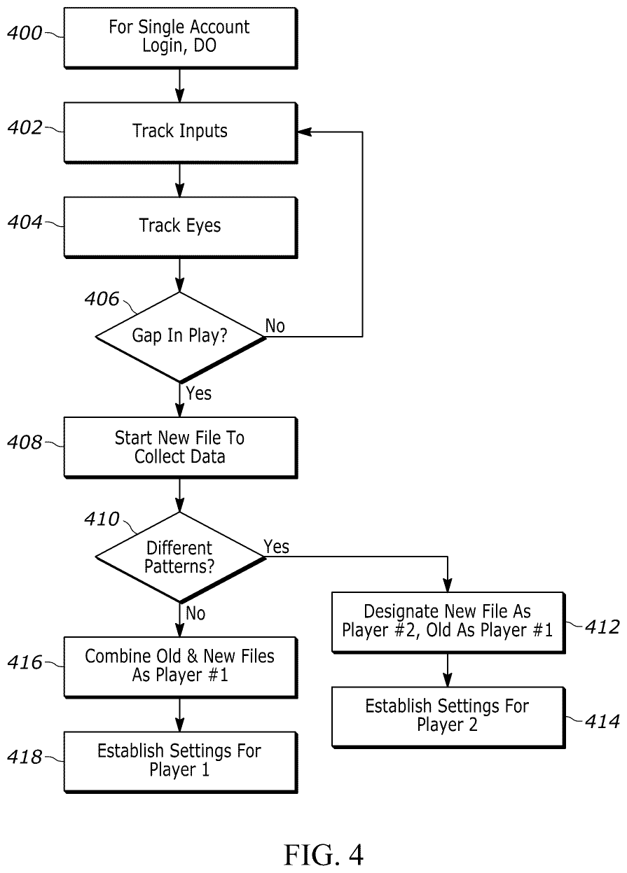

FIG. 4 illustrates example logic consistent with FIGS. 2 and 3. Commencing at state 400 for a login to a single computer game system account, the logic moves to state 402 to track inputs of the player made using the controller 204. Specific examples of inputs include browsing history but also game control inputs, which are inputs made via the controller to control play of a computer game within the computer game system, such as by controlling a player character (PC) of a computer game. The data from the controller can include specific buttons that were pushed, timestamps associated with each button push, motion data of the controller 204 as sensed by one or more motion sensors in the controller, title of game, skill level established, etc.

Also, as indicated at state 404 eye tracking may be used to detect gaze patterns of a player wearing, for example, the HMD 202. One or more RGB and/or IR cameras on the HMS 202, and/or console 206, and/or controller 204 may be used for this purpose. In any case, the inputs from the controller 204 and, if desired, eye tracking from state 404 may be recorded in a data structure such as a file.

State 406 indicates that the logic can determine whether a gap in game play (such as may be indicated by a gap in usage of the controller 204 or a gap in input of game play control signals) has occurred. Such a gap may indicate that another player had taken over control of the game. A gap may be indicated by a short period of time such as thirty seconds or a few minutes or longer period.

A gap in game play is but one technique for detecting the possibility of a new player taking over. Other techniques may be used, such as by face recognition, voice recognition, or even a direct input from a user interface that a different player has taken control using the same user account.

State 408 indicates that for a positive determination at state 406, a new data recording structure for recording controller inputs and, if desired, gaze tracking may be started, particularly for embodiments in which no overt indication is input that a new player has taken over. Controller input data and if desired gaze data collected subsequent to state 406 may be stored in the new file.

Proceeding to state 410, it is determined, by comparing the data collected before state 406 to the data collected after state 406, whether different game play and/or browsing patterns arose after state 406 on the single user account. A positive test result may be returned if usage patterns post-state 406 differ by a threshold amount from usage patterns pre-state 406.

Responsive to different patterns being returned, the logic moves to state 412 in which new data file from state 408 may be associated with a player #2 and the old data file from before state 406 may be associated with a player #1. Then, at state 414 new settings of the game system may be established for player #2 in accordance with further disclosure below. Without limitation, game system settings may include one or more of content, content recommendations, advertisements, artistic style of video display (color, font, etc.) speaker volume, display color background, controller settings, suggested titles, help assistance, accessibility settings, game presets including difficulty, performance mode, resolution mode, first or third person view, subtitles, language, and multiplayer session settings.

On the other hand, if, responsive to different patterns not being returned at state 410, the logic moves to state 416 in which the old and new data files discussed above may be combined into one and associated with player #1. State 418 indicates that game system settings for player #1, if not already established, are established.

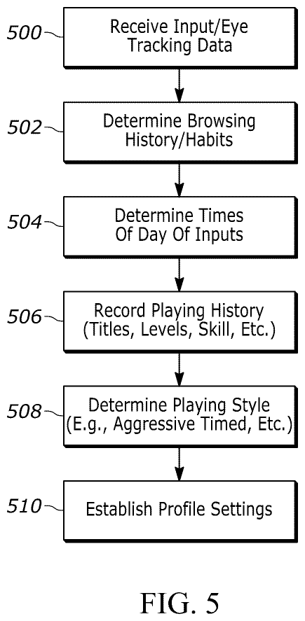

FIG. 5 illustrates techniques for generating player profiles that define the game control settings to be established for the respective player. Commencing at state 500, controller input and, if desired, eye tracking data is received. Based on the data at state 500, at state 502 the browsing history and/or game control input habits are learned. This may include associating time of day of controller use at state 504 and playing history at state 506, including what titles are being played, what skill level has been set or accepted by the player, motion patterns of the controller, and specific controller button manipulation patterns over time.

Moving to state 508, based on the preceding logic the playing style of the person wielding the controller is determined. For example, if motion patterns of the controller indicate vigorous motion, and button manipulation patterns indicate an offensive game play style versus an enemy, an aggressive style may be returned at state 508. Obversely, if motion patterns of the controller indicate gentle motion, and button manipulation patterns indicate an defensive game play style versus an enemy, a timid style may be returned at state 508.

Moving from state 508 to state 510, profile settings are established based on the logic of states 500-508. As an example, when player #1 is indicated as wielding the controller, computer game system systems observed as having been established by the player attendant to game play may be associated with the profile of player #1. Similarly, when player #2 is indicated as wielding the controller, computer game system systems observed as having been established by the player attendant to game play may be associated with the profile of player #2. Or, settings may be established automatically for each player.

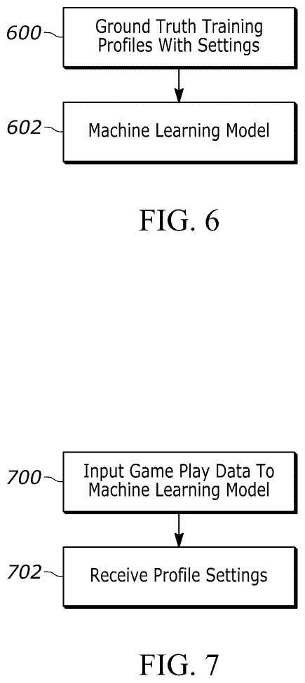

FIGS. 6 and 7 illustrate how this may be accomplished using machine learning (ML). Ground truth 600 that includes one or more of controller input patterns, controller motion patterns, browsing history, eye tracking patterns along with corresponding round truth computer game system settings are input to one or more ML models 602 to train the ML model 602 to generate computer game system settings based on the corresponding one or more of controller input patterns, controller motion patterns, browsing history, eye tracking patterns.

Once the ML model is trained, at state 700 in FIG. 7 subsequent gameplay data is input to the ML model, including one or more controller motion patterns, control input patterns, eye racking data, browsing history. The ML model outputs in response computer game system settings, which are received at state 702 and implemented for the single user account. The computer game system settings may be associated with the respective player generating the input to the ML model.

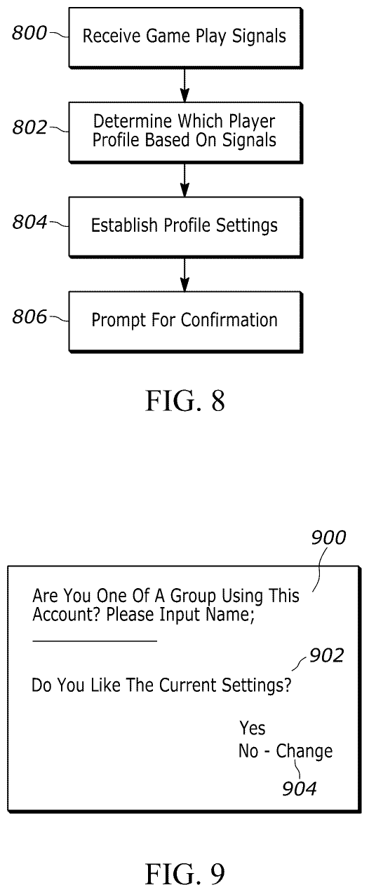

FIG. 8 reflects the disclosure above. Starting at state 800, the game play signals and other input signals discussed herein may be received and at state 802 which player profile best matches the input from state 800. The computer game system settings of the identified profile are established in the game system for the single user account at state 804.

State 806 indicates that if desired, the player may be prompted to confirm that the player is the player associated with the profile. FIG. 9 illustrates one example technique in which a query 900 is presented visibly and/or audibly on a display such as any display herein inquiring whether the player is one of a group of people using the single user account and prompting the player for a name. Also, the layer may be prompted at 902 as to whether the player likes the computer game system settings currently implemented by the game system and ma indicate approval or disapproval using selectors 904, with disapproval causing the system to alter one or more of the settings.

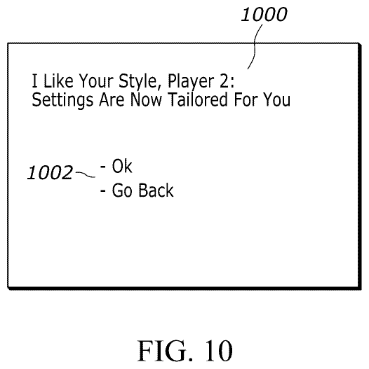

FIG. 10 extends the technique to an advisory 1000 which may be presented visibly and/or audibly on a display such as any display herein advising the current player that game system systems have been established for the current player. Selectors 1002 may be used by the player to accept the current systems or revert to the prior settings.

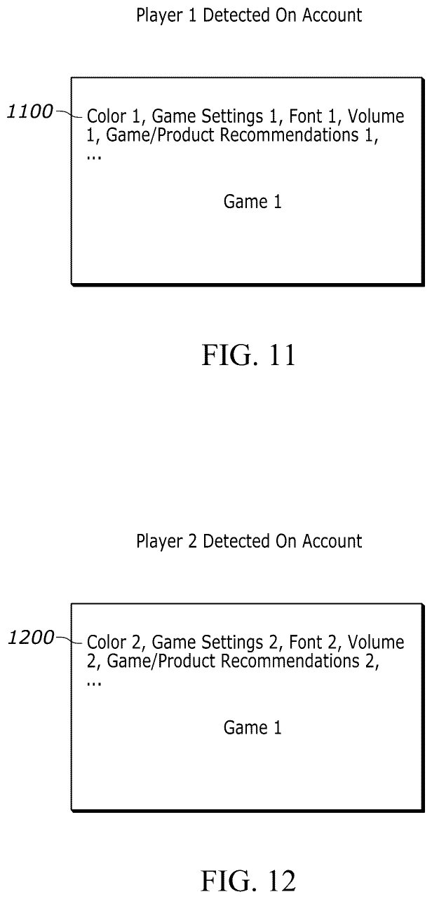

FIGS. 11 and 12 respective illustrate a display such as any display herein presenting a computer game via a single user account for respective players 1 (FIG. 11) and 2 (FIG. 12). Responsive to player #1 being detected as playing on the account, first game system settings 1100 including but not limited to first background display color, first font of text, first speaker volume, first game/product recommendations, etc. are implemented. On the other hand, responsive to player #2 being detected as playing on the account, second game system settings 1200 including but not limited to second background display color, second font of text, second speaker volume, second game/product recommendations, etc. are implemented.

While the particular embodiments are herein shown and described in detail, it is to be understood that the subject matter which is encompassed by the present invention is limited only by the claims.

What is claimed is:

1. A method comprising:
establishing computer game system settings associated with a first player profile for a computer game system account;
receiving game play signals from a computer game controller, the game play signals controlling at least one computer game; and
responsive to the game play signals, changing to computer game system settings associated with a second player profile for the computer game system account.

2. The method of claim 1, wherein the game play signals control a player character (PC) of the computer game.

3. The method of claim 1, wherein the game play signals comprise specific buttons pushed on the controller and timestamps associated with each button push.

4. The method of claim 1, comprising changing to computer game system settings associated with the second player profile for the computer game system account responsive to a gap in play of the computer game.

5. The method of claim 1, wherein the game system settings comprise one or more of content, content recommendations, advertisements, artistic style of video display, speaker volume, display color background, controller settings, suggested titles, help assistance, accessibility settings, and game presets including one or more of difficulty, performance mode, resolution mode, first or third person view, subtitles, language, and multiplayer session settings.

6. The method of claim 1, comprising:
inputting the game play signals to at least one machine learning (ML) model; and
receiving the second player profile from the ML model responsive to the inputting.

7. The method of claim 1, comprising presenting a prompt on at least one display to confirm correct game system settings are established.

9. A processor system configured to:
present, according to first system settings, a computer game via a single user account for a first player being detected as playing on the single user account; and
responsive to detecting a second player as playing on the single user account, automatically switch to presenting a computer game according to second system settings.

10. The processor system of claim 9, wherein the processor system is configured to:
detect which player is playing on the single user account based at least in part on game play signals from a computer game controller.

11. The processor system of claim 10, wherein the game play signals control a player character (PC) of the computer game.

12. The processor system of claim 10, wherein the game play signals comprise specific buttons pushed on the controller and timestamps associated with each button push.

13. The processor system of claim 10, wherein the processor system is configured for changing computer game system settings responsive to a gap in play of the computer game.

14. The processor system of claim 13, wherein the game system settings comprise one or more of content, content recommendations, advertisements, artistic style of video display, speaker volume, display color background, controller settings, suggested titles, help assistance, accessibility settings, and game presets including one or more of difficulty, performance mode, resolution mode, first or third person view, subtitles, language, and multiplayer session settings.

15. The processor system of claim 10, wherein the processor system is configured for:
inputting the game play signals to at least one machine learning (ML) model; and
receiving the second player profile from the ML model responsive to the inputting.

16. The processor system of claim 10, wherein the processor system is configured for presenting a prompt on at least one display to confirm correct game system settings are established.

17. A device comprising:
at least one computer memory that is not a transitory signal and that includes instructions executable by at least one processor system to:
analyze browsing history, active times, playing history, and playing style during active sessions of play of at least one computer game; and
based at least in part on the analyze, provide personalized experiences for respective users sharing a computer game system account.

18. The device of claim 17, wherein the instructions are executable to verify user identity by presenting a prompt on at leas one display to confirm identity.

19. The device of claim 17, wherein providing personalized experiences comprises implementing at least one computer game system settings comprising one or more of content, content recommendations, advertisements, artistic style of video display, speaker volume, display color background, controller settings, suggested titles, help assistance, accessibility settings, and game presets including one or more of difficulty, performance mode, resolution mode, first or third person view, subtitles, language, and multiplayer session settings.

20. The device of claim 17, wherein the playing style comprises specific buttons pushed on a game controller and timestamps associated with each button push.
